(19) United States
(12) Patent Application Publication
(10) Pub. No.: US 2011/0029161 A1
(43) Pub. Date: Feb. 3, 2011

(54) VISUAL AUTOPILOT FOR NEAR-OBSTACLE FLIGHT

(75) Inventors: Jean-Christophe Zufferey, Ecublens (CH); Antoine Beyeler, Chavannes (CH); Dario Floreano, St-Prex (CH)

Correspondence Address: IP GROUP OF DLA PIPER LLP (US), ONE LIBERTY PLACE, 1650 MARKET ST, SUITE 4900, PHILADELPHIA, PA, 19103, US

(73) Assignee: EPFL-SRI, Lausanne (CH)

(21) Appl. No.: 12/906,267

(22) Filed: Oct. 18, 2010

Related U.S. Application Data
(63) Continuation-in-part of application No. PCT/IB2008/051497, filed on Apr. 18, 2008.

(51) Int. Cl. G05D 1/10; G01C 19/02

(52) U.S. Cl. 701/4; 73/504.08

(57) ABSTRACT

This present invention describes a novel vision-based control strategy for autonomous cruise flight in possibly cluttered environments such as—but not limited to—cities, forests, valleys, or mountains. The present invention is to provide an autopilot that relies exclusively on visual and gyroscopic information, with no requirement for explicit state estimation nor additional stabilisation mechanisms.

This approach is based on a method of controlling an aircraft having a longitudinal axis comprising the steps of:
a) defining at least three viewing directions spread within frontal visual field of view,
b) acquiring rotation rates of the aircraft by rotation detection means,
c) acquiring visual data in at least said viewing directions by at least one imaging device,
d) determining translation-induced optic flow in said viewing directions based on the rotation rates and the visual data,
e) estimating the proximity of obstacles in said viewing directions based on at least the translation-induced optic flow,
f) for each controlled axes (pitch, roll and/or yaw), defining for each proximity, a conversion function to produce a converted proximity related to said controlled axe,
g) determining a control signal for each controlled axes by combining the corresponding converted proximities,
h) using said control signals to drive the controlled axes of the aircraft.

This is a continuation-in-part application of Application PCT/IB2008/051497, filed on Apr. 18, 2008.

### INTRODUCTION

This present invention describes a novel vision-based control strategy for autonomous cruise flight in possibly cluttered environments such as—but not limited to—cities, forests, valleys, or mountains. This invention allows controlling both the attitude and the altitude over terrain of an aircraft while avoiding collision with obstacles.

### PRIOR ART

So far, the vast majority of autopilots for autonomous aircrafts rely on a complete estimation of their 6 degree-of-freedom state, including their spatial and angular position, using a sensor suite that comprises a GPS and an inertial measurement unit (IMU). While such an approach exhibits very good performance for flight control at high altitude, it does not allow for obstacle detection and avoidance, and fails in cases where GPS signals are not available. While such systems can be used for a wide range of missions high in the sky, some tasks require near-obstacle flight, for example surveillance or imaging in urban environments or environment monitoring in natural landscapes. Flying at low altitude in such environments requires the ability to continuously monitor obstacles and quickly react to avoid them. In order to achieve this, we take inspiration from insects and birds, which do not use GPS, but rely mostly on vision and, in particular, optic flow (Egelhaaf and Kern, 2002, Davies and Green, 1994). This paper proposes a novel and simple way of mapping optic flow signals to control aircraft without state estimation in possibly cluttered environments. The proposed method can be implemented in a light-weight and low-consumption package that is suitable for a large range of aircraft, from toy models to mission-capable vehicles.

On a moving system, optic flow can serve as a mean to estimate proximity of surrounding obstacles (Gibson, 1950, Whiteside and Samuel, 1970, Koenderink and van Doorn, 1987) and thus be used to avoid them. However, proximity estimation using optic flow is possible only if the egomotion of the observer is known. For an aircraft, egomotion can be divided in rotational and translational components. Rotation rates about the 3 axes (FIG. 1) can easily be measured using inexpensive and lightweight rotation detection means (for example rate gyro or, potentially, using the optic-flow field itself). The components of the translation vector are instead much more difficult to measure on a free-flying platform. However, in most cases translation can be derived from the dynamics of the aircraft. Fixed-wing aircrafts typically have negligible lateral or vertical displacements, flying essentially along their longitudinal axis (x axis in FIG. 1). Rotorcraft behaviour is similar to fixed-wing platforms when they fly at cruise speed (as opposed to near-hover mode where translation patterns can be more complex). We therefore restrict our control strategy to the cases where the translation vector can be assumed to be aligned with the longitudinal axis of the aircraft. For the sake of simplicity, we use the term cruising to identify this flight regime. Note that in cruising the amplitude of the translation vector can easily be measured by means of an onboard velocity sensor (for example, a pilot tube, an anemometer, etc.). The observation that the translation vector has a fixed direction with respect to the aircraft allows to directly interpret optic flow measurements as proximity estimations, which can then be used for obstacle avoidance. While, in practice, there are small variations in the translation direction, they are sufficiently limited to be ignored.

Another common trait of most cruising aircraft is the way they steer. Most of them have one or more lift-producing wings (fixed, rotating or flapping) about which they can roll and pitch (see FIG. 1 for the axis name conventions). In standard cruise flight, steering is achieved by a combination of rolling in the direction of the desired turn and then pitching up. It is therefore generally sufficient to generate only two control signals to steer the aircraft corresponding to the roll and pitch controlled axes.

Recently, attempts have been made to add obstacle avoidance capabilities to unmanned aerial vehicles. For example, Scherer, Singh, Chamberlain, and Saripalli (2007) embedded a 3-kg laser range finder on a 95-kg autonomous helicopter. However, active sensors like laser, ultrasonic range finders or radars tend to be heavy and power consuming, and thus preclude the development of lightweight platforms that are agile and safe enough to operate at low altitude in cluttered environments.

Optic flow, on the contrary, requires only a passive vision sensor in order to be extracted, and contains information about the distance to the surroundings that can be used to detect and avoid obstacles. For example, Muratet, Doncieux, Briere, and Meyer (2005), Barber, Griffiths, McLain, and Beard (2005) and Griffiths, Saunders, Curtis, McLain, and Beard (2007) used optic flow sensors to perceive proximity of obstacles. However both systems still required GPS and IMU for altitude and attitude control. Other studies included optic flow in the control of flying platforms (Barrows et al., 2001, Green et al., 2003, Chahl et al., 2004), but the aircraft were only partially autonomous, regulating exclusively altitude or steering and thus still requiring partial manual control. Optic flow has received some attention for indoor systems for which GPS is unavailable and weight constraints are even stronger (Ruffier and Franceschini, 2005, Zufferey et al., 2007), but complete autonomy has yet to be demonstrated. Finally, Neumann and Bülthoff (2002) proposed a complete autopilot based on visual cues, but the system still relied on a separate attitude stabilisation mechanism that would require an additional mean to measure verticality (for example, an IMU).

### BRIEF DESCRIPTION OF THE INVENTION

In contrast to these results, the approach of the present invention is to provide an autopilot that relies exclusively on visual and gyroscopic information, with no requirement for explicit state estimation nor additional stabilisation mechanisms.

This approach is based on a method of controlling an aircraft having a longitudinal axis comprising the steps of:

a) defining at least three viewing directions spread within frontal visual field of view,

b) acquiring rotation rates of the aircraft by rotation detection means,

c) acquiring visual data in at least said viewing directions by at least one imaging device,

d) determining translation-induced optic flow in said viewing directions based on the rotation rates and the visual data,

e) estimating the proximity of obstacles in said viewing directions based on at least the translation-induced optic flow,

f) for each controlled axes (pitch, roll and/or yaw), defining for each proximity, a conversion function to produce a converted proximity related to said controlled axe,

g) determining a control signal for each controlled axes by combining the corresponding converted proximities,

h) using said control signals to drive the controlled axes of the aircraft.

### BRIEF DESCRIPTION OF THE FIGURES

The present invention will be better understood thank to the attached figures in which:

FIG. 1: Aerodynamical coordinate system of the aircraft reference frame. For convenience, the name of the three rotation directions is also indicated.

FIG. 2: Overview of the steps required to map the data provided by an imaging device and rate detection means into control signals.

FIGS. 3a-c: A large field-of-view is desirable to detect potentially dangerous obstacles on the aircraft trajectory.

FIG. 3a: An example image in the frontal field of view taken with a fisheye lens.

FIG. 3b: The image plane coordinate system used throughout this text. Ψ is the azimuth angle (Ψε[0;2π]), with Ψ=0 corresponding to the dorsal part of the visual field and positive extending leftward. θ is the polar angle (θε[0;π]).

FIG. 3c: Perspective sketch of the same vision system.

FIG. 4: Subjective representation of the region where proximity estimations are useful and possible for obstacle anticipation and avoidance. The original fisheye image is faded away where it is not useful.

FIG. 5: Sampling of the visual field. N sampling points are uniformly spaced on a circle of radius \hat{θ}. On this illustration, N=16 and \hat{θ}=45°.

FIG. 6: Overview or the control architecture.

FIG. 7a: Qualitative distribution of weights wₖ^{P} for the generation of the pitching control signal. The arrow in the centre indicates the pitch direction for a positive signal.

FIG. 7b: Weight distribution according to equ. (4).

FIG. 8a: Qualitative distribution of weights wₖ^{R} for the generation of the rolling control signal. The arrow in the centre indicates the roll direction for a positive signal.

FIG. 8b: Weight distribution according to equ. (5).

FIG. 9: Trajectory of the simulated aircraft when released 80 m above a flat surface, oriented up-side down, with a nose-down pitch of 45° and zero speed.

FIG. 10: Image of the simulated environment, comprising obstacles of size 80×80 m and height 150 m surrounded by large walls.

FIG. 11: Trajectories of the simulated aircraft in the test environment.

FIG. 12: Generic version of the control architecture proposed in this paper.

FIG. 13: Conceptual representation of steering by shifting the roll weight distribution around the roll axis.

### DETAILED DESCRIPTION OF THE INVENTION

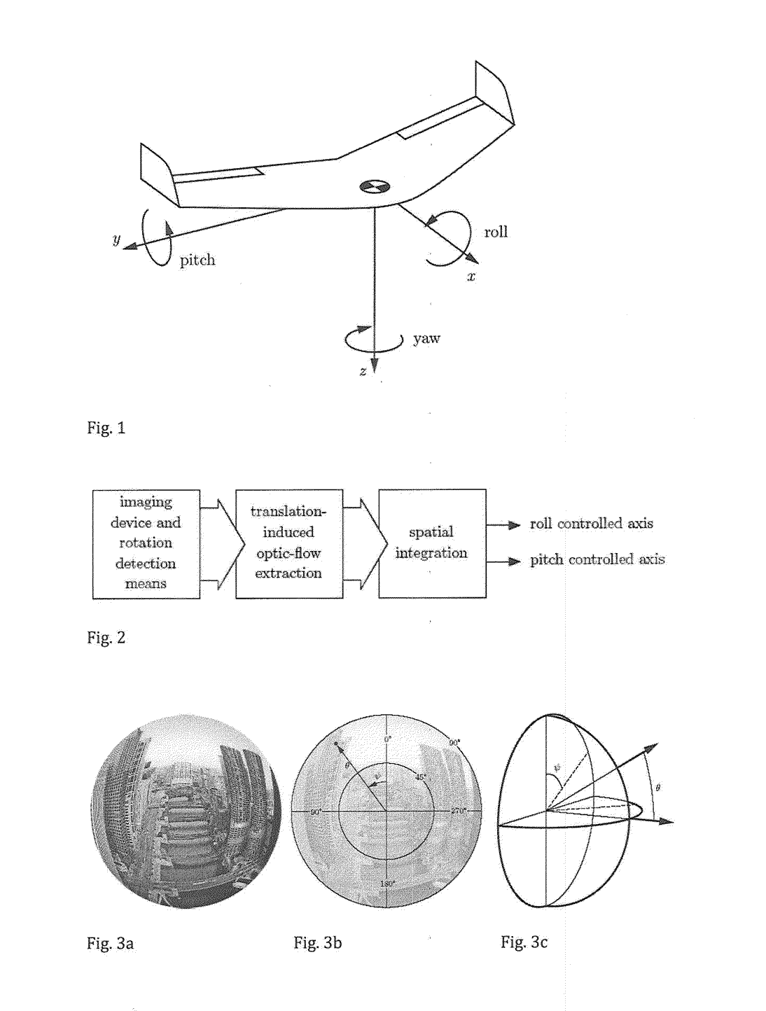

The proposed vision-based control strategy requires the steps illustrated in FIG. 2 to map the data provided by the embedded sensors (typically an imaging device—also called vision system—looking forward with a large field of view (e.g. FIG. 3a) and three orthogonal rate gyros as rate detection means) into signals that can be used to drive the aircraft's controlled axes. First, the optic flow must be extracted from the information provided by the embedded vision system.

### 2.1 Proximity Estimation Using Translation-Induced Optic Flow

The fundamental property of optic flow that enables proximity estimation is often called motion parallax (Whiteside and Samuel, 1970). Essentially, it states that the component of optic flow that is induced by translatory motion (called hereafter translational optic flow or translation-induced optic flow) is proportional to the magnitude of this motion and inversely proportional to the distance to obstacles in the environment. It is also proportional to the sine of the angle α between the translation direction and the looking direction. This can be written

$${p}_{T} ( θ , ψ ) = \frac{\vert T \vert}{D ( θ , ψ )} sin ( α ) \qquad ( 1 )$$

where p_{T}(θ,Ψ) is the amplitude of translation-induced optic flow seen in direction (θ,ψ) (see FIG. 3 for the coordinate system convention), T is the translation vector, D(θ,Ψ) is the distance to obstacle seen in direction (θ,Ψ) and α is the angle between the translation vector T and the viewing direction (θ,Ψ).

Consequently, in order to estimate proximity of obstacles, it is recommended to exclude the optic flow component due to rotations, a processed known as derotation and implemented by some processing means. In an aircraft, this can be achieved by predicting the optic flow generated by rotation signalled by rate gyros or inferred from optic flow field, and then subtracting this prediction from the total optic flow extracted from vision data. Alternatively, the vision system can be actively rotated to counter the aircraft's movements.

In the context of cruise flight, the translation vector is essentially aligned with the aircraft's main axis at all time. If the vision system is attached to its platform in such way that its optic axis is aligned with the translation direction, the angle α in equ. (1) is equal to the polar angle θ (also called eccentricity). Equ. (1) can then be rearranged to express the proximity to obstacle μ (i.e. inverse of distance, sometime also referred as nearness):

$$μ ( θ , ψ ) = \frac{1}{D ( θ , ψ )} ∝ \frac{{p}_{T} ( θ , ψ )}{sin ( θ )} \qquad ( 2 )$$

This means that the magnitude of translation-induced optic flow in a given viewing direction, as generated by some processing means, can be directly interpreted by some calculation means as a measure of proximity of obstacles in that direction, scaled with the sine of eccentricity θ in the viewing direction.

### 2.2 Viewing Directions and Spatial Integration

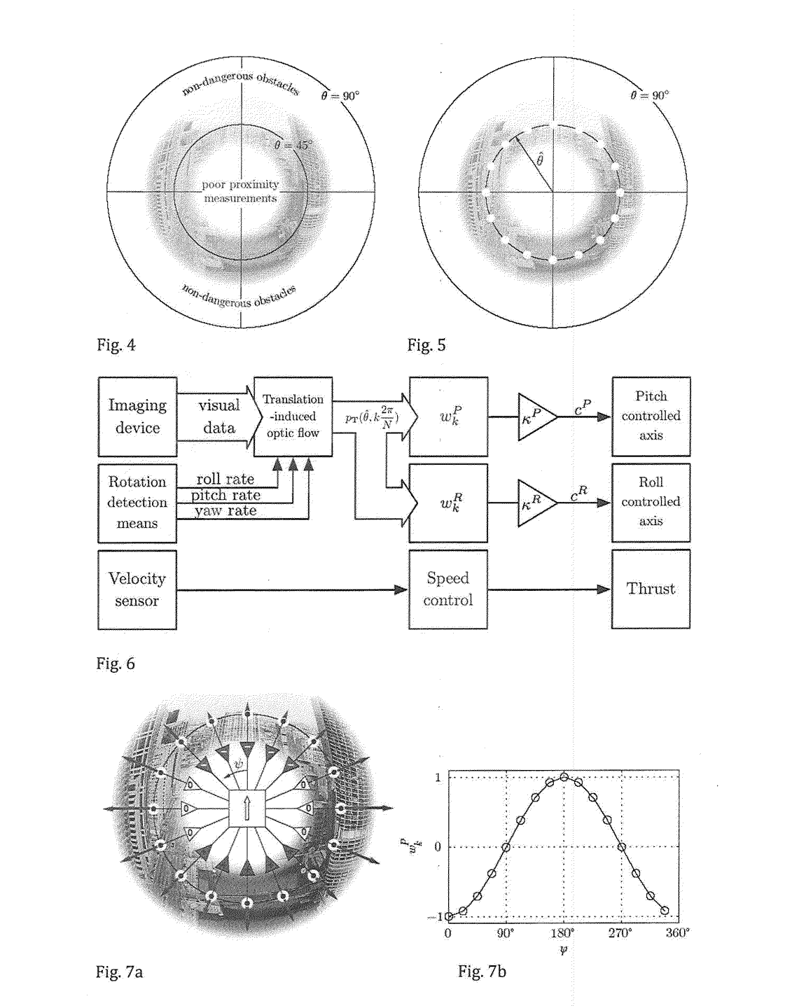

The next question concerns the selection of the viewing directions in which the translation-induced optic flow should be measured, how many measurements should be taken, and how these measurements should be combined to generate control signals for the aircraft. In order to reduce the computational requirements, it is desirable to reduce the number of measurements as much as possible. It turns out that not all the viewing directions in the visual field have the same relevance for flight control. For θ>90°, these estimations correspond to obstacles that are behind the aircraft and do not require anticipation or avoidance. For θ values close to 0, the magnitude of optic flow measurements will decrease down to zero (i.e. in the centre of the visual field), because it is proportional to sin(θ) (see equ. (1)). Since the vision system resolution will limit the capability to measure small amounts of optic flow, proximity estimation will not be accurate at small eccentricities θ. These constraints define a domain in the visual field roughly spanning polar angles around θ=45°, illustrated in FIG. 4, where optic flow measurement are significant for controlling the course of an aircraft.

We propose to measure equ. (2) at N points uniformly spread on a circle defined by a given polar angle \hat{θ}. These N points are defined by angles

$$( {θ}_{k} ; {ψ}_{k} ) = ( \hat{θ} ; k \frac{2 π}{N} ) , k = 0 , 1 , … N - 1.$$

This sampling is illustrated in FIG. 5.

The control signals of the aircraft, such as roll and pitch, can be generated from a linear summation of the weighted measurements:

$${c}^{j} = \frac{{κ}^{j}}{N \cdot sin ( \hat{θ} )} \cdot {\sum }_{k} {p}_{T} ( \hat{θ} , k \frac{2 π}{N} ) \cdot {w}_{k}^{j} \\ k = 0 , 1 , … N - 1 \qquad ( 3 )$$

where c^{j} is the j^{th} control signal, wₖ^{j} the associated set of weights and κ^{j} a gain to adjust the amplitude of the control signal. This summation process is similar to what is believed to happen in the tangential cells of flying insects (Krapp et al., 1998); namely, a wide-field integration of a relatively large number of motion estimations into a reduced number of control-relevant signals.

In a more generic way, this process can be seen as a two-stage transformation of proximities into control signals. First, the proximities are individually converted using a specific conversion function implemented by some conversion means (e.g. a multiplication by a weight). Second, the converted proximities are combined by some combination means (e.g. using a sum) into a control signal. It is worth noting that all converted proximities will be combined (with specific weights) to obtain the control signal on a single axis. Finally, the control signals are then used by some driving means to drive the controlled axes of the aircraft. While this simple weighted sum approach is sufficient to implemented functional autopilots, there may be the need to use more complex, possibly non-linear, conversion functions and combinations.

The above described solution does not explicitly measure the attitude of the aircraft, but rather continuously reacts to the proximity of objects, it is therefore not possible to directly regulate a desired roll angle. The roll angle is in fact implicitly regulated by the perceived distribution of optic flow, which is integrated through the roll weight distribution {wₖ^{R}}. If we assume that the aircraft is flying over flat terrain, the optic-flow amplitudes will be symmetrically distributed between left and right only when the aircraft flies with zero roll. Otherwise the claimed process will strive to reach this symmetrical distribution of optic flow and therefore bring the aircraft back to level flight. An elegant way of acting on the implicitly regulated roll angle is by internally shifting the roll weight distribution around the roll axis, as illustrated in the FIG. 13. Shifting this weight distribution clockwise (respectively counterclockwise) of a certain angle will result in a left (resp. right) banked attitude of approximately the same angle. For example, shifting the weight distribution by 30° counterclockwise will steer, over flat terrain, the aircraft to a roll angle close to 30° instead of the level attitude regulated by the unshifted, symmetrical weight distribution. As soon as the roll angle of an aircraft deviates from the level attitude, its lift vector is tilted and the aircraft steers in the corresponding direction. The weight distribution shift can therefore be linked to a lateral steering command, which could be provided for instance by a human operator or a GPS-based navigation controller. The FIG. 7b shows a distribution of the weights in function of the angle between the viewing direction and the controlled axis. The maximum weight is applied for the converted proximity that is in line with the controlled axis. The converted proximities that are out of that direction still impact the controlled axis but in a reduced way since the weight applied to this converted proximity is lower. The weight shifting as described above has the consequence that the maximum weight will no longer apply to the converted proximity in line with the controlled axe.

### 2.3 Roll and Pitch Controlled Axes

The majority of aircraft are steered using mainly two control signals corresponding to roll and pitch rotations (note that additional control signals, e.g. for yaw axis, can be generated similarly). To use the approach described in the previous section, two sets of weights wₖ^{R} and wₖ^{P} must be devised, for the roll and, respectively, pitch control. Along with a speed controller to regulate cruising velocity, this system forms a complete autopilot as illustrated in FIG. 6. Data from the imaging device and rotation detection means is used to extract translation-induced optic flow. Optic flow measurements p_{T} are then linearly combined using two sets of weights wₖ^{R} and wₖ^{P}, corresponding to pitch and roll controlled axes. In parallel, the thrust is controlled by a simple regulator to maintain cruising speed, based on measurements from a velocity sensor.

Let us first consider the pitch control signal c^{P} (FIG. 7). Proximity signals in the ventral region (i.e. Ψ near 180% see FIG. 3 for angle conventions) correspond to the presence of obstacles in the ventral part of the aircraft. Corresponding weights should thus be positive to generate a positive control signal which in turn will produce a pitch-up manoeuvre that leads to avoidance of the obstacle. Likewise, weights in the dorsal region corresponding to the area above the aircraft (i.e. ψ near 0°) should be negative in order to generate pitch-down manoeuvres. Lateral proximity estimations (i.e. Ψ near) ±90° should not influence the pitching behaviour, and thus corresponding weights should be set to zero. A possible way of determining these weights is given by (FIG. 7b):

$${w}_{k}^{P} = - cos ( k \cdot \frac{2 π}{N} ) \qquad ( 4 )$$

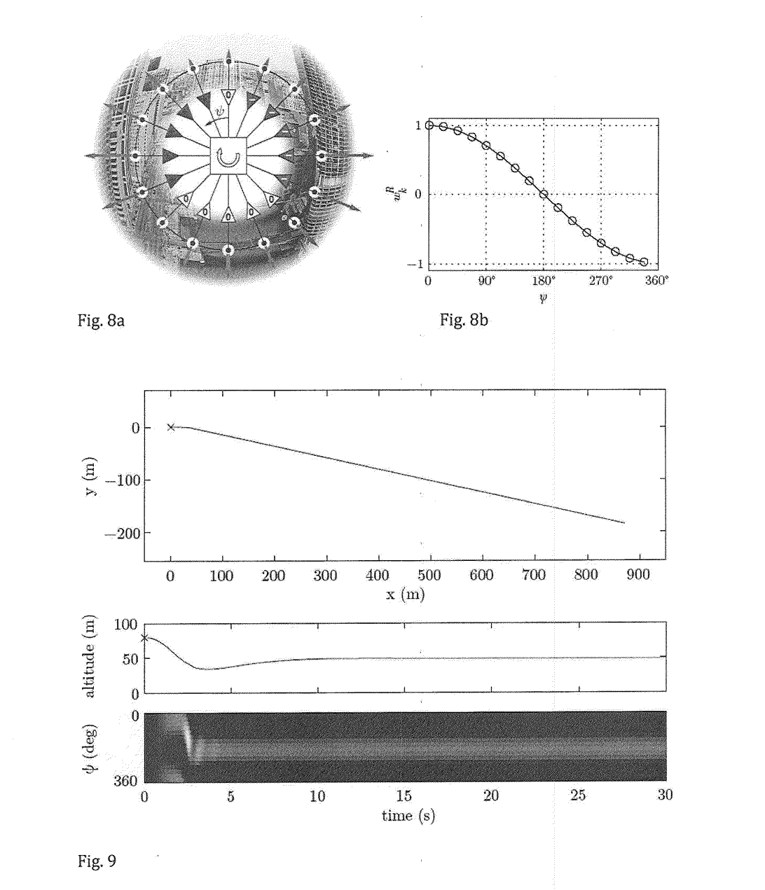

Using the same reasoning, the qualitative distribution needed for the weights related to the roll signal can be derived (FIG. 8). Weights corresponding to the left of the aircraft should be positive, in order to initiate a rightward turn in reaction to the detection of an obstacle on the left. Inversely, weights on the right should be negative. Since obstacles in the ventral region (Ψ=180°) are avoided by pitch signal only, the weights in this region should be set to zero. At first sight, the same reasoning should apply for the dorsal region. However, doing so would be problematic when the aircraft is in an upside down position (i.e. with the ventral part facing sky). In such situations, it may be desirable to steer the aircraft back to an upright and level attitude. This can be achieved by extending the non-zero weights of the lateral regions up to the dorsal field-of-view, as illustrated in FIG. 8a. These weights, combined to the proximity of ground in the dorsal region, will generate a roll signal leading to the levelling of the aircraft. The following equation is one way to implement such a weight distribution (FIG. 8b):

$${w}_{k}^{R} = cos ( k \cdot \frac{π}{N} ) \qquad ( 5 )$$

### Proof of Concept

In order to assess the performance of the complete autopilot described above (FIG. 6), we tested it in two simulated environments. The first one, a flat, obstacle-free environment is used to show the capacity of the autopilot to recover from extreme situations and regulate flight to a stable altitude and attitude. The second environment, mimicking an urban setting, is used to demonstrate the full obstacle avoiding performance.

### 3.1 Simulation Setup

To test the control strategy, we used a simulation package called Enlil that relies on OpenGL for rendition of image data and the Open Dynamics Engine (ODE) for the simulation of the physics.

We use a custom-developed dynamics model based on the aerodynamic stability derivatives (Cooke et al., 1992) for a commercially available flying wing platform called Swift that we use as platform for aerial robotics research at our laboratory (Leven et al, 2007). The derivatives associate a coefficient for each aerodynamical contribution to each of the 6 forces and moments acting on the airplane and linearly sum them. The forces are then passed to ODE for the kinematics integration. So far, these coefficients have been tuned by hand to reproduce the behaviour of the real platform. While the resulting model may not be very accurate, it does exhibit dynamics that are relevant to this kind of aircraft and is thus sufficient to demonstrate the performance of our autopilot.

There are many optic flow extraction algorithms that have been developed and could be used (Horn and Schunck, 1981, Nagel, 1982, Barron et al., 1994). The one that we used is called image interpolation algorithm (I2A) (Srinivasan, 1994). In order to derotate the optic flow estimations, i.e. remove the rotation induced part to keep the translational component only as discussed in the above section, we simply subtracted the value of the rotational speed of the robot, as it would be provided by rate gyros on a real platform.

Table 1 summarises the parameters that were used in the simulation presented in this paper. The speed regulator was a simple proportional regulator with gain set to 0.1 and set-point to 25 m/s.

TABLE 1
Parameter values used in the simulations.

| Parameter | Value |
|---|---|
| \hat{θ} | 45° |
| N | 16 |
| κ^{E} | 5 |
| κ^{A} | 60 |
| wₖ^{E} | according to |
| | equ. (4) |
| wₖ^{A} | according to |
| | equ. (5) |

### 3.2 Flying Over a Flat Ground

The initial test for our control strategy consisted of flying over an infinitely flat ground without obstacles. The result of a simulation of this situation is shown in FIG. 9. To test the capability of the controller to recover from extreme situations, the aircraft was started upside-down, with a 45° nose-down attitude and a null speed. Immediately, the aircraft recovered to a level attitude and reached its nominal speed. Although altitude was not explicitly regulated in our control architecture, the system quickly stabilised and maintained a constant altitude (of about 50 m above ground in this case). Such behaviour arises from the equilibrium between the gravity that pulls the aircraft toward the ground and the upward drive from the controller that detects the ground as an obstacle.

In the FIG. 9, it is illustrated the aircraft when released 80 m above a flat surface, initialised upside-down with 45° nose-down attitude and null speed. Within a few seconds, the aircraft recovers from this attitude and starts flying along a straight trajectory, as seen on the top graph. The middle graph shows that in the beginning, the aircraft quickly looses some altitude due to the fact that it starts a zero speed and nose-down attitude, and then recovers and maintains a constant altitude. The bottom graph shows the distribution of translational optic flow around the field of view (brighter points means higher translation-induced optic flow). The distribution quickly shifts from the dorsal to the ventral region as the aircraft recovers from the upside-down position. The controller then maintains the peak of the distribution in the ventral region for the rest of the trial.

### 3.3 Flying Among Buildings

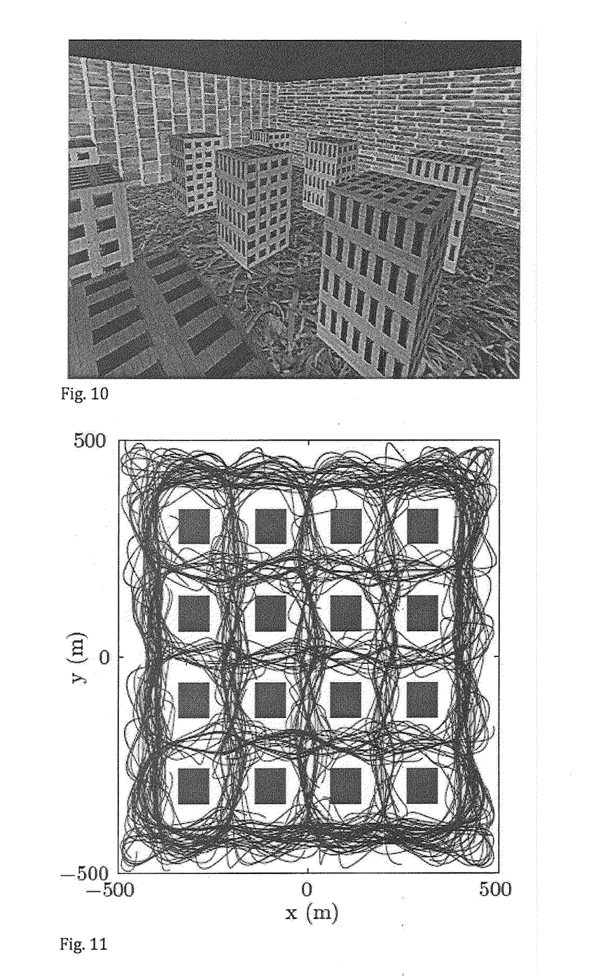

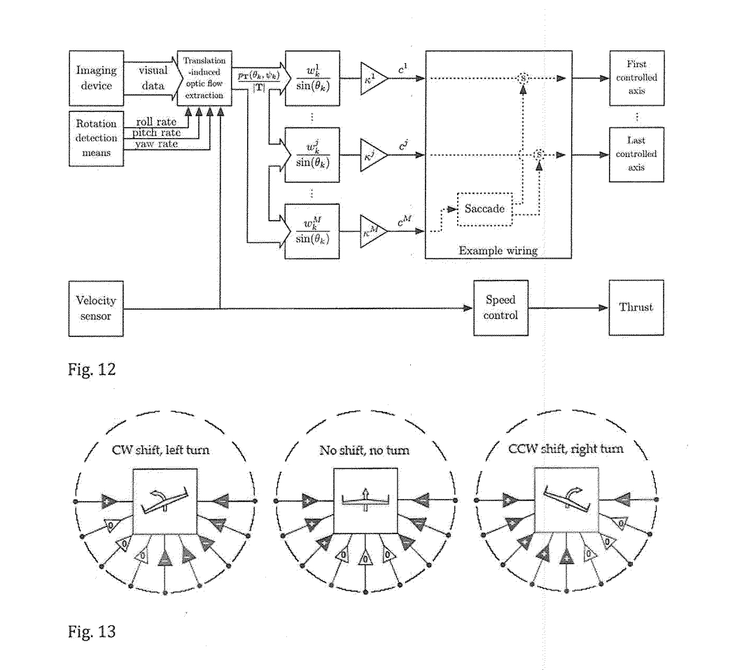

To test the obstacle avoidance capability of the control strategy, we ran simulations in a 500×500-m test environment surrounded by large walls comprising obstacle of size 80×80 m and height 150 m (FIG. 10). Obstacles the size of buildings were placed at regular intervals within this arena (red squares in FIG. 11). The aircraft was started at random locations, below the height of the obstacles and between them, and with a null speed. It was then controlled using the autopilot for 20 seconds. The 2D projections of 512 trajectories are shown in FIG. 11. This result illustrates the capability of our control strategy to avoid the obstacles in this environment, independently of their relative position with respect to the aircraft. The rare cases (less than 10) in which the aircraft closely approached or crossed the obstacles do not correspond to collisions, as the aircraft sometimes fly above them.

### Discussion

In this section we discuss various extensions of the control architecture presented above, which can be used to address specific needs of other platforms or environments.

### 4.1 Estimation of Translational Optic Flow

While the control strategy we propose has a limited computing power requirement, the optic flow extraction algorithms can be computationally expensive. Moreover, a vision system with a relatively wide field-of-view—typically more than 100°—is recommended in order to acquire visual data that is relevant for control (see FIG. 4). Therefore, careful hardware design will be needed to limit consumption and weight. Initial development in our laboratory show that a vision system weighing about 10 g and electronics weighing 30 g and consuming roughly 2 W are sufficient to run our system, allowing for a platform with a total weight of less than 300 g to be developed.

To make even lighter systems, alternative approaches to optic flow extraction could be used by using different sorts of imaging device. First, custom-designed optic flow chips that compute optic flow at the level of the vision sensor (e.g. Moeckel and Liu, 2007) can be used to offload the electronics from optic flow extraction. This would allow the use of smaller microcontrollers to implement the rest of the control strategy. Also, the imaging device can be made of a set of the optical chips found in modern computer mice, each chip being dedicated to a single viewing direction. These chips are based on the detection of image displacement, which is essentially optic flow, and could potentially be used to further lighten the sensor suite by lifting the requirement for a wide-angle lens.

Finally, any realistic optic flow extraction is likely to contain some amount of noise. This noise can arise from several sources, including absence of contrast, aliasing (in the case of textures with high spatial frequencies) and the aperture problem (see e.g. Mallot, 2000). In addition, moving objects in the scene can also generate spurious optic flow that can be considered as noise. To average out the noise, a large number of viewing directions and corresponding translation-induced optic flow estimations may be required to obtain a stable simulation.

### 4.2 Saccade

In most situations, symmetrical behaviour is desirable. For this reason, most useful sets of weights (or more generally, conversion functions) will be symmetrical as well, as is the case for the proposed distributions in equ. (4) and equ. (5). However, when facing certain situations—like flying perpendicularly toward a flat surface—the generated control signals can remain at a very low value, even though the aircraft is approaching an obstacle. While this problem occurs rarely in practice, it may be necessary to cope with it explicitly. This situation will typically exhibit a massive, global increase of optic flow in all directions, and can be detected using an additional control signal c^{S} with corresponding weights wₖ^{S}=1 for all k. An emergency saccade, i.e. an open-loop avoiding sequence that performs a quick turn, can be triggered when this signal reaches a threshold. During the saccade, the emergency signal c^{S} can be monitored and the manoeuvre can be aborted as soon as c^{S} decreases below the threshold.

### 4.3 Alternative Sampling of the Visual Field

For the sake of simplicity, we previously suggested the use of a simple set of viewing directions, along a single circle at θ=\hat{θ}, to select the locations where proximity estimation are carried out. The results show that this approach is sufficient to obtain the desired behaviour. However, some types of platforms or environments may require denser set of viewing directions. This can also be useful to average out noise in optic flow estimation, as discussed above. There are some of the many approaches that can be used.
One possibility is to use several circles at θ=\hat{θ}ᵢ, i=1, . . . , M. Doing so makes it possible to simply re-use the same set of weights for each circle, effectively increasing the visual coverage with a minor increase in control complexity.
Some optic flow extraction algorithms typically provide estimations that are regularly spaced on a grid on the image. While such a sampling scheme is not as intuitive as the circular one we propose, it can still easily be used by selecting only the estimations that fall within the region of interest described in section 2.2. Using the same distributions as given in equ. (4), the weights corresponding to the pitch control become:

wₖ^{P}=−cos(Ψₖ) (6)
where θₖ is the azimuth angle for the k^{th} sampling point. The other sets of weights can be similarly adapted. The control signals are then computed as follows:

$${c}^{j} = \frac{{κ}^{j}}{N} {\sum }_{k} \frac{{p}_{T , k}}{sin ( {θ}_{k} )} \cdot {w}_{k}^{j} \qquad ( 7 )$$

where θₖ is the polar angle for the k^{th} sampling point.
It may be desirable to behave differently for obstacles in the centre of the visual field than for obstacles that are more eccentric to the flight trajectory, for example because they are more likely to lie on the trajectory of the aircraft. For this reason, it can, in general, be useful to distribute weights in a way that is dependent of θₖ as well as Ψₖ, i.e.:

wₖ^{j}=f^{j}(θₖ,Ψₖ) (8)
where (θₖ;Ψₖ) are the coordinates of the k^{th} optic flow estimation.

### 4.4 Minimal Set of Viewing Directions

In general, for this control strategy to work, it requires at least tree viewing directions one of it being out of the plane defined by two others.

According the main embodiment of the invention, each converted proximity calculated from the optical flow of the corresponding viewing direction is then used to determine the control signal of a specific axe. This means that all converted proximities will be then used to calculate the control signal of a single axe. For the sake of generality, we have considered so far N viewing directions, where N should be as large as the implementation permits. However, in case of very strong constraints, the minimal number of viewing directions for a fully autonomous, symmetrical aircraft is 3: left-, right- and downward. The left/right pair of viewing direction is used to drive the roll controlled axis, while the bottom viewing direction is used to drive the pitch controlled axis. For this minimalist implementation, the top viewing direction can be omitted based on the assumption that no obstacle are likely to be encountered above the aircraft, as it is the case in most environments.

### 4.5 Speed Regulation

In our description, we silently assumed that forward speed is maintained constant at all times. While such a regulation can be relatively easily implemented on real platforms, it may sometimes be desirable to fly at different speeds depending on the task requirements. We discuss here the two approaches that can be used in this case.

The simplest option is to ignore speed variations and consider proximity estimation as a time-to-contact information (Lee, 1976, Ancona and Poggio, 1993). For a given distance to obstacle, a faster speed will yield a higher optic flow value than a reduced speed (equ. (1)). The aircraft will then avoid obstacles at a greater distance when it is flying faster which is a perfectly reasonable behaviour (Zufferey, 2005).

Alternatively, the forward speed can be measured by the velocity sensor and explicitly taken into consideration in the computation of the control signals by dividing them by the amplitude of translation |T|. For example, equ. (3) becomes:

$${c}^{j} = \frac{{κ}^{j}}{\vert T \vert \cdot N \cdot sin ( \hat{θ} )} \cdot {\sum }_{k} {p}_{T} ( \hat{θ} , k \frac{2 π}{N} ) \cdot {w}_{k}^{j} \\ k = 0 , 1 , … N - 1 \qquad ( 9 )$$

### REFERENCES

N. Ancona and T. Poggio. Optical flow from 1D correlation: Application to a simple time-to-crash detector. In Proceedings of Fourth International Conference on Computer Vision, Berlin, pages 209-214, 1993.
D. B. Barber, S. Griffiths, T. W. McLain, and R. W. Beard. Autonomous landing of miniature aerial vehicles. In AIAA Infotech@Aerospace, 2005.
J. L. Barron, D. J. Fleet, and S. S. Beauchemin. Performance of optical flow techniques. International Journal of Computer Vision, 12 (1):43-77, 1994.
G. L. Barrows, C. Neely, and K. T. Miller. Optic flow sensors for MAV navigation. In Thomas J. Mueller, editor, Fixed and Flapping Wing Aerodynamics for Micro Air Vehicle Applications, volume 195 of Progress in Astronautics and Aeronautics, pages 557-574. AIAA, 2001.
J. S. Chahl, M. V. Srinivasan, and H. Zhang. Landing strategies in honeybees and applications to uninhabited airborne vehicles. The International Journal of Robotics Research, 23 (2):101-110, 2004.
J. M. Cooke, M. J. Zyda, D. R. Pratt, and R. B. McGhee. Npsnet: Flight simulation dynamic modeling using quaternions. Presence: Teleoperators and Virtual Environments, 1 (4):404-420, 1992.
M. N. O. Davies and P. R. Green. Perception and Motor Control in Birds. Springer-Verlag, 1994.
M. Egelhaaf and R. Kern. Vision in flying insects. Current Opinion in Neurobiology, 12(6):699-706, 2002.
J. J. Gibson. The Perception of the Visual World. Houghton Mifflin, Boston, 1950.
W. E. Green, P. Y. Oh, K. Sevcik, and G. L. Barrows. Autonomous landing for indoor flying robots using optic flow. In ASME International Mechanical Engineering Congress and Exposition, Washington, D.C., volume 2, pages 1347-1352, 2003.
S. Griffiths, J. Saunders, A. Curtis, T. McLain, and R. Beard. Obstacle and Terrain Avoidance for Miniature Aerial Vehicles, volume 33 of Intelligent Systems, Control and Automation: Science and Engineering, chapter 1.7, pages 213-244. Springer, 2007.
B. K. Horn and P. Schunck. Determining optical flow. Artificial Intelligence, 17:185-203, 1981.
J. J. Koenderink and A. J. van Doorn. Facts on optic flow. Biological Cybernetics, 56:247-254, 1987.
H. G. Krapp, B. Hengstenberg, and R. Hengstenberg. Dendritic structure and receptive-field organization of optic flow processing interneurons in the fly. Journal of Neurophysiology, 79:1902-1917, 1998.
D. N. Lee. A theory of visual control of braking based on information about time-to-collision. Perception, 5:437-459, 1976.
S. Leven, J.-C. Zufferey, D. Floreano. A low-cost, safe and easy-to-use flying platform for outdoor robotic research and education. In International Symposium on Flying Insects and Robots. Switzerland, 2007.
H. A. Mallot. Computational Vision: Information Processing in Perception and Visual Behavior. The MIT Press, 2000.
R. Moeckel and S.-C. Liu. Motion Detection Circuits for a Time-To-Travel Algorithm. In IEEE International Symposium on Circuits and Systems, pp. 3079-3082. 2007.
L. Muratet, S. Doncieux, Y. Briere, and J. A. Meyer. A contribution to vision-based autonomous helicopter flight in urban environments. Robotics and Autonomous Systems, 50(4): 195-209, 2005.
H. H. Nagel. On change detection and displacement vector estimation in image sequences. Pattern Recognition Letters, 1:55-59, 1982.
T. R. Neumann and H. H. Bülthoff. Behavior-oriented vision for biomimetic flight control. In Proceedings of the EPSRC/BBSRC International Workshop on Biologically Inspired Robotics, pages 196-203, 2002.
F. Ruffier and N. Franceschini. Optic flow regulation: the key to aircraft automatic guidance. Robotics and Autonomous Systems, 50(4): 177-194, 2005.
S. Scherer, S. Singh, L. Chamberlain, and S. Saripalli. Flying fast and low among obstacles. In Proceedings of the 2007 IEEE Conference on Robotics and Automation, pages 2023-2029, 2007.
M. V. Srinivasan. An image-interpolation technique for the computation of optic flow and egomotion. Biological Cybernetics, 71: 401-416, 1994.
J. H. van Hateren and C. Schilstra. Blowfly flight and optic flow. II. head movements during flight. Journal of Experimental Biology, 202: 1491-1500, 1999.
T. C. Whiteside and G. D. Samuel. Blur zone. Nature, 225: 94-95, 1970.
J.-C. Zufferey. Bio-inspired vision-based flying robots. Ph.D. thesis, EPFL, 2005.
J.-C. Zufferey, A. Klaptocz, A. Beyeler, J.-D. Nicoud, and D. Floreano. A 10-gram vision-based flying robot. Advanced Robotics, Journal of the Robotics Society of Japan, 21(14): 1671-1684, 2007.

1. A method for avoiding collision with obstacles, controlling altitude above terrain and controlling attitude of an aircraft having a longitudinal axis defined by its flying direction comprising the steps of:
a) defining at least three viewing directions, each characterised by an eccentricity and an azimuth angle, spread within the frontal visual field of view, with at least one of it being out of the plane defined by two others.
b) acquiring rotation rates of the aircraft by rotation detection means,
c) acquiring visual data in at least said viewing directions by at least one imaging device,
d) determining translation-induced optic flow in said viewing directions based on the rotation rates and the visual data,
e) for each viewing direction, estimating the proximity of obstacles of said viewing direction based on at least the translation-induced optic flow related to said viewing direction,
f) for each controlled axes (pitch, roll and/or yaw), defining for each proximity, a conversion function that depends on the eccentricity and the azimuth angle of the corresponding viewing directions to produce a converted proximity related to said controlled axis,
g) determining a control signal for each controlled axis by combining all corresponding converted proximities,
h) using said control signals to drive the controlled axes of the aircraft.

2. Method of claim 1, it further comprises the step of:
acquiring an image by the imaging device encompassing the viewing directions and extracting the visual data related to each viewing direction.

3. Method of claim 1, in which the imaging device is made of a set of optic flow sensors, each dedicated to each viewing direction.

4. Method of claim 1, wherein the rotation detection means is made of gyroscopic means and/or inertial sensors.

5. Method of claim 1, wherein the rotation detection means is using the imaging device, the rotation data being determined by processing optic flow extracted from the visual data.

6. Method of claim 1, wherein the viewing directions are spread at a given eccentricity with respect to the longitudinal axis of the aircraft, and each conversion function is a multiplication by a specific gain, also named weight, that depends on the eccentricity and the azimuth angle of the corresponding viewing directions, said set of weights corresponding to a controlled axis is defined as a weight distribution.

7. Method of claim 1, wherein the viewing directions are spread at various eccentricities with respect to the longitudinal axis of the aircraft, and each conversion function is a multiplication by a specific gain and a division by the sine of the eccentricity of the corresponding viewing direction.

8. Method of claim 1, wherein the combination of the converted proximities is an averaging function.

9. Method of claim 6, wherein it comprises the step of shifting the weight distribution to cause the airplane to roll.

10. A device for avoiding collision with obstacles, controlling altitude above terrain and controlling attitude of an aircraft having a longitudinal axis defined by its flying direction comprising:
rotation detection means to acquire rotation rates of the aircraft,
at least one imaging device to acquire visual data in at least three viewing directions, each characterised by an eccentricity and an azimuth angle, spread within frontal visual field of view of said aircraft, with at least one of it being out of the plane defined by two others
processing means to determine translation-induced optic flow in said viewing directions based on the rotation rates and the acquired visual data,
calculation means to estimate the proximity of obstacles in said viewing directions based on at least the translation-induced optic flow,
conversion means for, for each controlled axes (pitch, roll and/or yaw), defining for each proximity, that produce a converted proximity related to said controlled axis,
combination means to determine a control signal for each controlled axes by combining the corresponding converted proximities, said combination depending on the eccentricity and the azimuth angle of the corresponding viewing directions
driving means to apply said control signals to drive the controlled axes of the aircraft.

11. Device of claim 10, in which the imaging device is made of a set of optic flow sensors, each dedicated to each viewing direction.

12. Device of claim 10, wherein the rotation detection means are made of rate gyro and/or inertial sensors.
